(19) United States
(12) Patent Application Publication
(10) Pub. No.: US 2023/0367924 A1
(43) Pub. Date: Nov. 16, 2023

(54) System and Method for Fast Computer Simulation of Injection Molding

(71) Applicant: Dassault Systemes Simulia Corp., Johnston, RI (US)

(72) Inventors: Xiaoshi Stone Jin, Ithaca, NY (US); Shiaw Yuh Chiou, Taiwan (CN)

(21) Appl. No.: 17/743,015

(22) Filed: May 12, 2022

(51) Int. Cl. G06F 30/20; B29C 45/76

(52) U.S. Cl. CPC G06F 30/20; B29C 45/76

(57) ABSTRACT

A computer-implemented method and corresponding computer-based system perform a computer simulation, via at least one processor, of a filling stage of an injection molding process that fills a part cavity of a part with material over a filling time. The simulation is based on a boundary integration method and a mesh model. The mesh model represents the part cavity. The simulation computes a part thickness distribution of the part based on the mesh model. The boundary integration method computes velocity and temperature at a flow front of the material over the part thickness distribution computed and determines advancement of the flow front based on the velocity and temperature computed. The simulation outputs, via the processor, at least one indication of behavior of the injection molding process determined based on the simulation. The simulation transpires in real-time relative to the filling time.

### BACKGROUND

Injection molding is amongst the most important manufacturing methods for mass production of net-shape plastics parts in the plastics industry. Plastics parts can be complicated three-dimensional (3D) geometric designs. Design engineers of such parts typically use a CAD (Computer-Aided Design) tool to design/modify a model of the part and use a CAE (Computer-Aided Engineering) simulation tool to iteratively check the model design for manufacturability, dimensional precision, potential defects, and verify engineering performance. Such iterative CAD-CAE tools are also used in mold tool design for injection gate (inlet) location determination, feed system design, cooling system design, and process parameter optimization. A plastics material selection decision for the part may be based on molding dimensional stability comparisons and engineering performance analyzed with a set of simulation tools.

### SUMMARY

Various embodiments of the present disclosure relate generally to computer simulation of an injection molding process. Such computer simulation enables manufacturing of plastic parts, mold design, and control over an injection molding machine in the manufacturing of plastic parts for non-limiting example. An example embodiment enables rapid computer simulation to match, or nearly match, a filling time (e.g., pre-set fill time) of a filling stage of the injection molding process. A part, according to an example implementation, is a mold for manufacturing a real-world article. As such, a part cavity, as referred to herein, may be a mold cavity.

It should be understood that use of articles “a,” “an,” and the term “at least one” herein does not limit a noun following same to a single instance of the noun. For example, “a processor” and “at least one processor” may encompass multiple processors or processor cores for the execution of a computer program.

Example embodiments enable an amount of computational time taken to simulate, by a processor for non-limiting example, a filling stage of a part (mold) cavity to be on the order of an amount of time taken to actually fill a real-world part cavity of a part (mold) during an actual filling stage performed in the real-world during an actual injection molding manufacturing process involving an object corresponding to the part. In other words, embodiments provide functionality where the time it takes to simulate filling a part cavity and the time it takes in the real-world to fill the part cavity are on the same order of magnitude.

Conventional simulation tools may take many minutes or hours, sometimes even days, to complete a filling stage simulation. This limits the number of simulations that can be performed by a computer-based system during a window of time. Example embodiments disclosed herein expedite computation time of the computer-based system, via a novel formulation of equations and corresponding method disclosed further below, so as to enable the computer-based system to simulate a filling stage of an injection molding process in considerably less time relative to conventional simulation methods and in a real-time range of the filling stage. As such, a number of simulation runs that can be performed in the window of time is increased by improving simulation performance of the computer-based system, such improvement to the simulation performance effectuated via the novel formulation.

While an example embodiment may be described with regard to plastics part design, it should be understood that embodiments are not limited to polymer-based part design. Further, while an example embodiment may be described with regard to gate (inlet) location optimization for mold design, it should be understood that embodiments are not limited to such an application and may, for non-limiting example, be useful as a real-time physics tool for smart control, material data online fitting, digital twins in manufacturing, or any other application where simulation, design, and optimization of cavity filling is desired. Computer simulation may be performed on a computer-based system, as disclosed further below, and via a computer-implemented method, disclosed below with regard to the following example embodiment.

According to an example embodiment, a computer-implemented method for determining behavior of an injection molding process may comprise simulating in real-time, via at least one processor, a filling stage of an injection molding process that fills a part cavity of a part with material over a filling (fill) time. Such behavior may be a pattern of a flow of material filling a mold cavity over time. The simulating may be based on a boundary integration method and a mesh model. The mesh model may represent the part cavity. The simulating may include computing a part thickness distribution of the part based on the mesh model. The boundary integration method may include computing velocity and temperature at a flow front of the material over the part thickness distribution computed and determining advancement of the flow front based on the velocity and temperature computed. The computer-implemented method may further comprise outputting, via the processor, at least one indication of behavior of the injection molding process determined based on the simulating. The at least one indication of behavior may include a filling pattern representing the filling stage, e.g., a visual or other such representation of material flow over time. Amongst other examples, this representation may be provided through color-coded or shade-coded imagery or through a numeric or alphanumeric representation of the behavior. It should be understood that the at least one indication is not limited to a filling pattern and may encompass any behavior of the injection molding process that results from the simulation, or that may be derived based on the simulation. For non-limiting example, said behaviors may be physics-based, materials-based, and/or chemistry-based.

The simulating may transpire in real-time relative to the filling time. For example, if the filling time is on the order of seconds, real-time is also on the order of seconds, and if the filling time is on the order of minutes, real-time is also on the order of minutes for non-limiting example. Real-time may match the actual (real-world) filling time or may be within a range, such as within 5%, 10%, etc. of the actual filling time, for non-limiting example. As such, the simulating can be performed in real-time or near real-time relative to filling time. Specifically, example embodiments enable an amount of CPU/GPU time taken to simulate, by a CPU/GPU for non-limiting example, a filling stage of a part cavity of a part to be on the order of an amount of time taken to actually fill a real-world part cavity of the part during an actual filling stage performed in the real-world during an injection molding manufacturing process using the part.

The boundary integration method may further include employing a representation of a moving boundary of the flow front. The representation of the moving boundary may be a one-dimensional (1D) element.

The boundary integration method may further include computing an incremental pressure drop. The advancement may be determined using the incremental pressure drop computed.

Determining the advancement of the flow front may include determining, on a time-step-by-time-step basis, advancement of a moving boundary of the flow front of the material within the part cavity represented by the mesh model. The simulating may include advancing, on the time-step-by-time step basis, the moving boundary based on the advancement determined for the moving boundary.

The boundary integration method may be based on a 1D boundary-integration equation set of partial differential equations (PDEs). The determining may include solving, by the at least one processor, the 1D boundary-integration equation set of PDEs. Determining the advancement of the moving boundary may include solving, by the at least one processor, the 1D boundary-integration set of PDEs.

The moving boundary may include a plurality of boundary elements. The advancement of the moving boundary may be determined using element layers of the mesh model so as to guide advancement of the plurality of boundary elements. The boundary integration method may further include employing, on the time-step-by-time-step basis, a time increment that prevents a boundary element of the plurality of boundary elements from advancing more than two element layers of the element layers of the mesh model within the time increment. In other words, such an implementation may use a time increment in which a boundary element advances two or less element layers.

The at least one indication of behavior of the injection molding process may include a filling pattern representing the filling stage. It should be understood that the at least one indication is not limited to a filling pattern and may encompass any behavior of the injection molding process that results from the simulation, or that may be derived based on the simulation. For non-limiting example, said behaviors may be physics-based, materials-based, and/or chemistry-based.

The at least one indication may include a graphical representation of the filling stage of the part cavity over time. Outputting the at least one indication may include displaying the graphical representation on a display screen of a computer device for non-limiting example.

The material may be a polymer for non-limiting example. The part cavity may be a thin-wall part cavity. The mesh model may be a mid-plane mesh model or a surface mesh model of the thin-wall part cavity.

The mesh model representing the part cavity may be a discretized surface representation of a geometry of the part cavity. The boundary integration method may further include determining, on a time-step-by-time-step basis, advancement of a moving boundary of the flow front of the material. The moving boundary may include a plurality of flow front nodes. At each time step of determining the advancement of the moving boundary, the determining may include:
(a) computing the part thickness distribution from the discretized surface representation of the geometry of the part cavity;
(b) determining process parameters, the process parameters including flow rate distribution and time steps based on input process conditions;
(c) computing an average thickness distribution of the flow front and an average fluidity of the flow front;
(d) computing an average advancing speed of the flow front;
(e) computing an average temperature of the flow front;
(f) computing a temperature-and-shear-rate dependent integration for fluidity on each flow front node of the plurality of flow front nodes;
(g) computing a flow front nodal speed for each flow front node of the plurality of flow front nodes, wherein computing the flow front nodal speed includes employing a speed ratio and the average advancing speed;
(h) advancing the moving boundary of the flow front according to each flow front nodal speed computed, the advancing being within the discretized surface representation of the geometry of the part cavity, the advancing producing an advanced flow front location;
(i) computing pressure and temperature distributions according to the advanced flow front location produced and, based on the pressure and temperature distributions computed, determining whether an injection-molding-machine related pressure limit has been reached or a whole flow front temperature has dropped below a polymer freezing-point temperature, wherein the material is a polymer with the polymer freezing-point temperature, and determining whether the part cavity has been filled, completely; and
(j) ending the simulating in an event the injection-molding-machine related pressure limit is determined to have been reached, the whole flow front temperature is determined to have dropped below the polymer freezing-point temperature, or the part cavity is determined to have been filled, completely, and, in an event the simulating is not ended, repeating (b)-(j) for a next time step.

According to another example embodiment, a computer-based system for determining behavior of an injection molding process may comprise at least one memory and at least one processor coupled to the at least one memory. The at least one processor may be configured to perform a computer simulation, in real-time. The computer simulation may include simulating a filling stage of an injection molding process that fills a part cavity of a part with material over a filling time. The simulating may be based on a boundary integration method and a mesh model. The mesh model may be stored in the at least one memory and represent the part cavity. The simulating may include computing a part thickness distribution of the mesh model. The boundary integration method may include computing velocity and temperature at a flow front of the material over the part thickness distribution computed and determining advancement of the flow front based on the velocity and temperature computed. The at least one processor may be further configured to output at least one indication of behavior of the injection molding process determined based on the simulating. The simulating may transpire in real-time relative to the filling time.

Alternative computer-based system embodiments parallel those described above in connection with the example method embodiment.

It should be understood that example embodiments disclosed herein can be implemented in the form of a method, apparatus, system, or non-transitory computer readable medium with program codes embodied thereon.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A is a block diagram of an example embodiment of a computing environment in which a design engineer is using a computer-based system for fast computer simulation of injection molding.

FIG. 1B is a schematic view of an example embodiment of a real-time simulation tool for smart control of an injection molding manufacturing process.

FIGS. 2A-C are line drawings of example embodiments of linear boundary elements and boundary nodes.

FIG. 3 is a representation of an issue that may result from a ray-tracing method.

FIG. 4A is a plot of an edge and corner thickness issue that may result from a shrinking-ball method.

FIG. 4B is a plot of a result of applying a correction method to the shrinking-ball method.

FIG. 5A is a plot of an example embodiment of a split of a flow front at a juncture.

FIG. 5B is a block diagram of an example embodiment of a bi-surface model with a gate on one surface.

FIG. 5C is a block diagram of an example embodiment of a split flow front.

FIGS. 6A-B are plots of example embodiments of flow front advancement for two consecutive time steps.

FIG. 7 is a schematic view of an example embodiment of the flow front advancement of FIGS. 6A-B.

FIG. 8 is a schematic view of an example embodiment of building triangles of a mesh by connecting nodes of flow front curves.

FIG. 9A is a schematic view of an example embodiment of flow front advancement with a time step that is too small.

FIG. 9B is a schematic view of an example embodiment of flow front advancement with a time step that is too big.

FIG. 10 is a thickness distribution plot of an example embodiment of a thickness distribution of a square plate used in a test case.

FIG. 11 is a plot of an example embodiment of a filling pattern that results from a two-gate injection molding simulation according to the present disclosure.

FIG. 12 is a depiction of an example embodiment of a surface mesh model of a test case.

FIG. 13 is a plot of another example embodiment of a filling pattern that results from a two-gate injection molding simulation according to the present disclosure.

FIG. 14 is a plot of an example embodiment of a filling pattern result of the present disclosure on a three-dimensional (3D) hexahedron (hex) mesh.

FIG. 15 illustrates geometry of a model employed in a case study of an example embodiment.

FIG. 16 is a schematic top-view of a fan gate of a plaque used as a model geometry in a test case.

FIGS. 17A-B are plots of pressure predictions.

FIG. 18 is a flow diagram of an example embodiment of a computer-implemented method for fast computer simulation of injection molding.

FIG. 19 is a block diagram of an example of the internal structure of a computer in which various embodiments of the present disclosure may be implemented.

### DETAILED DESCRIPTION

A description of example embodiments follows.

A Glossary defining terms used herein is provided further below.

While an example embodiment disclosed herein may describe a material as being a polymer, it should be understood that the material is not limited to same.

In the real-world, a filling stage of an injection molding process typically completes in seconds, or in a fraction of a second. Conventional simulation tools typically complete the filling stage simulation in an amount of time that is a few orders of magnitude higher than the actual time (real-time filling time) it takes to complete the filling stage, that is, the actual time to fill a mold cavity of a part (mold).

Simulation tools for the injection molding process have been extensively developed and improved over time based on mature numerical methods, such as finite volume and finite element methods, which are based on a discretized mesh of a part cavity. Depending on the complexity of a part geometry and accuracy requirements, a three-dimensional (3D) mesh of such a part cavity can include tens of thousands, often millions of elements. Thus, domain mesh-based simulation methods may take many minutes or hours, or sometimes even days to complete.

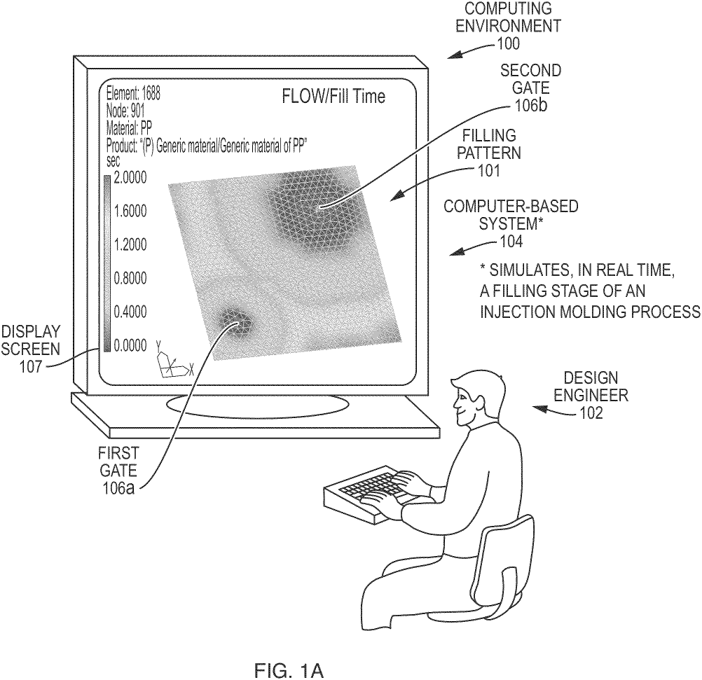

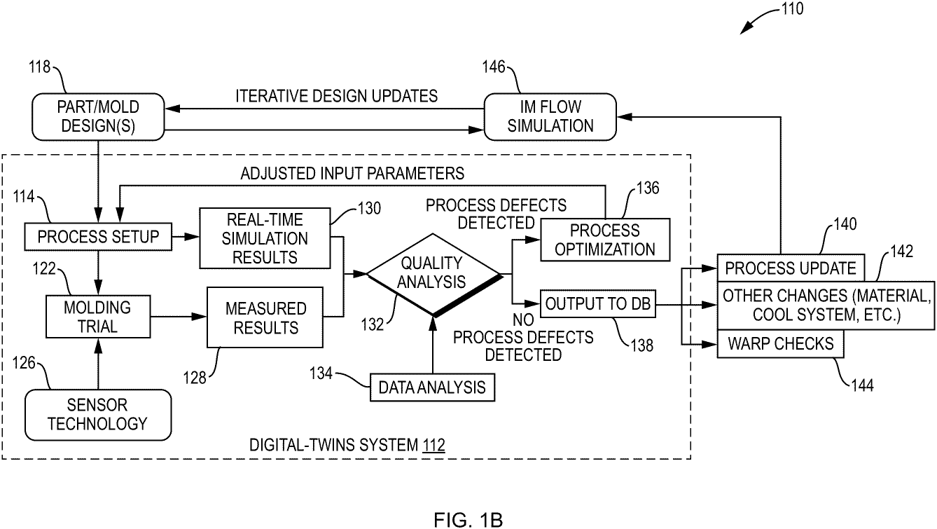

What is more, a simulation project typically needs to simulate multiple scenarios of process conditions, or iteratively perform design optimization, which may involve a plurality of simulation runs. It would be useful for the turn-around time of such simulations to be in line with the actual injection molding process, which typically takes seconds to complete. An example embodiment of a computer-implemented method and computer-based system enable same, as disclosed below with regard to FIG. 1A.

FIG. 1A is a block diagram of an example embodiment of a computing environment 100 in which a design engineer 102 is using a computer-based system 104 for fast computer simulation of injection molding. Injection molding simulation as described herein may be employed as part of an iterative design process and may be further employed for controlling an injection molding process in real-time, as disclosed below with reference to FIG. 1B.

FIG. 1B is a schematic view of an example embodiment of a real-time simulation tool 110 for smart control of an injection molding manufacturing process. The simulation tool 110 may be used for controlling an injection molding process in real-time. The simulation tool 110 includes a digital-twins system 112. The digital twins system 112 may be a virtual representation (digital model) of a real-world injection molding (IM) process that may be implemented via a computer-based system, such as the computer-based system 104 of FIG. 1A. The digital twins system 112 may be employed to identify IM process defects, e.g., injection pressure, and the system 112 can be used to update the real-world IM manufacturing process in real-time to improve the injection molding process and the part that results therefrom. The digital-twins system 112 may be a replication of a real-world production system in a digital model.

The digital-twins system 112 may implement process setup 114 of an IM process. The process setup 114 may be performed based on a part (mold) design(s) 118 of a real-world mold (part) input to an injection molding machine (not shown). The part (mold) design(s) 118 may provide process parameters, such as temperature, pressure, and/or speed to name but a very few non-limiting process parameters. Following the process setup 114, a molding trial 122 may begin, i.e., a real-world injection molding process is performed. The molding trial 122 may receive sensor data from sensor technology 126 put into the real-word mold.

The sensor technology 126 includes real-world sensors that produce sensor data in the real-world. The sensor data may be used by the digital twins system 112 to represent, digitally, the real-word molding trial 122 (or manufacturing process as a whole) enabling the digital twins system 112 to produce measured results 128 that represent, digitally, physical measurements. Said measured results 128, along with real-time simulation results 130, may be employed by the digital twins system 112 for performing quality analysis 132 of the injection molding process, i.e., the molding trial 122. The quality analysis 132 may employ data from a data analysis 134, such data including historical data that may be used as a reference for identifying process defects in the IM process (molding trial 122) and defects in the mold used and part resulting from the IM process.

The quality analysis 132 may determine whether or not a process defect(s) is/are present based on the real-time simulation results 130, measured results 128, and data provided from the data analysis 134. For instance, the analysis 132 may compare the simulation results 130 and measured results 128 and, based on historical data from the data analysis 134, determine if a distinction between the simulation results 130 and measured results 128 is a defect. In an event a process defect(s) is/are detected, the digital twins system 112 may perform process optimization 136 to adjust at least one process parameter that may be input to the process setup 144 to cause the process setup 114 to be adjusted for a next iteration of the molding trial 122 toward improving the injection molding process.

If the quality analysis 132 does not detect a process defect, an indication regarding same may be output 138 to a database (DB) (not shown) and an external computational system (not shown), external to the digital-twins system 112, may perform a process update 140, or other changes 142, such as a change to a material of the mold, change to a cooling system used to cool the mold, etc. for non-limiting example. The external computational system may further perform warp checks 144 of the mold, such as via a visual inspection system that employ a camera(s) for non-limiting example.

The process update 140, other changes 142, and/or warp checks 144 may cause a change to an IM flow simulation 146 performed external to the digital-twins system 112, as disclosed further below. An example embodiment disclosed herein may be employed in the digital twins system 122 to enable the real-time simulation results 130 to be produced in real-time for controlling a real-world IM process in real-time, i.e., as the IM process is being performed, and may further be employed in the IM flow simulation 146, performed external to the digital-twins system 112, to speed up an iterative part/mold design process, as disclosed below.

With reference to FIGS. 1A and 1B, to perform the IM flow simulation 146, the design engineer 102 may create computer-aided design (CAD) part(s) using the computer-based system 104. Such CAD parts (molds) may include cavities, inserts, cooling channels, and runners for non-limiting examples. The design engineer 102 may define boundary conditions on such CAD entities that may be employed by the computer-based system 104 for simulation. The computer-based system 104 may create a mesh. The mesh partitions each domain of the simulation model, such as the cavity, cooling channel, and runner, into many cells. The design engineer 102 may input selected materials for the model components (molds, inserts, etc.) into the computer-based system 104. The design engineer 102 may input process parameters, such as melt temperature, injection time, mold temperature, packing pressure, packing time, cooling time, etc., for non-limiting examples.

The design engineer 102 may provide user input to the computer-based system 104 that causes the computer-based system 104 to perform the IM flow simulation 146 and the computer-based system 104 may output at least one indication (not shown) of behavior of the injection molding process. For non-limiting example, the indication may include a filling pattern 101 representative of filling the cavity of the part (i.e., mold) in a filling stage. The at least one indication may be output, for non-limiting example, to a display screen 107 (or otherwise rendered with audio, video, multi-media, etc.) of the computer-based system 104 for user interaction. The at least one indication may be a filling pattern 101 that indicates, via variation of color for non-limiting example, flow/fill time of the part cavity (i.e., mold cavity) resulting from injection of material at a first gate 106a location and a second gate location 106b. Alternatively, the at least one indication may be output by storing the at least one indication electronically, for example, to an electronic or digital data file in computer memory for non-limiting example.

The at least one indication may indicate if there is a problem/defect with the part design. If no problems or defects are detected, the simulation project may be considered complete. If there is a problem with the part design, however, the simulation process may continue. For example, the computer-based system 104 may employ alternate gate (inlet) locations, for non-limiting example. The computer-based system 104 may be used to simulate the behavior of alternative materials and process conditions. Further, the computer-based system 104 may refine the mesh and rerun another simulation to verify that the results are independent of the mesh density. Since the simulation process may be iterative, involving multiple simulations, it is useful for the computer-based system 104 to simulate the filling time of the part cavity in real-time relative to the actual (real-world) filling time.

For example, some thin-wall part cavities may just take a fraction of a second to fill completely. As such, CAD design evaluation that has a quick turn-around would be useful. A gate location optimization tool should not take hours to recommend the best gate locations, and a control tool for an injection molding machine should adjust parameters based on a fast response of a simulation tool within a molding cycle. Achieving such goals may be enabled by using a fast flow solver as the simulation tool. An example embodiment of the computer-based system 104 enables same.

The computer-based system 104 may receive input data including process update data 140, other change data 142, and warp check data 144. Said data (140, 142, 144) can be employed in an iterative design workflow implemented by the system 104 for designing and constructing a part and corresponding mold (to be used in an IM process for manufacturing the part). This iterative design workflow may use existing part design tools along with user input and the IM flow simulation 146 to develop an optimized design of the real-world part and corresponding mold. The workflow may utilize the real-time simulation methodology described herein to design a part and mold that can be properly manufactured using IM techniques. By utilizing embodiments as part of the part and mold design workflow, the workflow improves production speed of the part by more quickly determining an appropriate design. When an appropriate design is determined, said design 118 can be provided to the digital-twins system 112 for controlling/implementing/enabling the manufacturing.

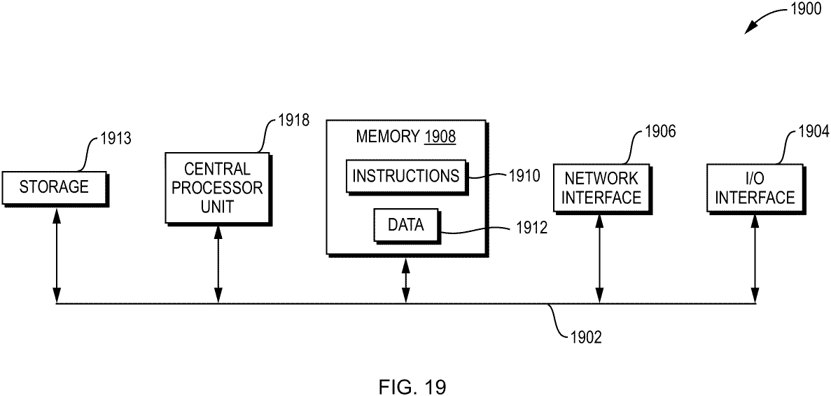

The computer-based system 104 comprises at least one memory and at least one processor coupled to the at least one memory, such as the central processor unit 1918 coupled to the memory 1908, disclosed further below with regard to FIG. 19 for non-limiting example. According to a non-limiting example embodiment, the at least one processor may include at least one graphics processing unit (GPU). The at least one processor may be configured to perform a computer simulation. The computer simulation may include simulating a filling stage of an injection molding process that fills a part cavity (not shown in FIG. 1A) of a part (not shown in FIG. 1A) with material over a real-time filling time. The filling stage may be represented by the filling pattern 101 and filling pressure, temperature, volumetric shrinkage, sink mark, etc. The computer-based system 104 that simulates same may be referred to herein as a “flow solver.”

The at least one processor may be configured to perform a computer simulation, in real-time. The computer simulation may include simulating a filling stage of an injection molding process that fills a part cavity (not shown in FIG. 1A) of a part (not shown not shown in FIG. 1A) with material over a filling time. The filling stage is represented by the filling pattern 101. The simulating is based on a boundary integration method and a mesh model (not shown). The mesh model may be stored in the at least one memory and represents the part cavity. The simulating may include computing a part thickness distribution (not shown in FIG. 1A) of the mesh model. The boundary integration method may include computing velocity and temperature at a flow front of the material over the part thickness distribution computed and determining advancement of the flow front based on the velocity and temperature computed. Such a flow front is shown as via the filling pattern 101 as advancing over time. The at least one processor may be further configured to output at least one indication of behavior of the injection molding process determined based on the simulating. The simulating may transpire in real-time relative to the filling time. As such, the computer-based system 104 may further be referred to herein as a “fast” flow-solver.

The material may be a polymer for non-limiting example. The boundary integration method may be considered a fast-numerical method for polymer flows within a thin-wall injection molding system for a physics model-based software simulation of an injection molding process. The physics model includes conservation laws, material property models and parameters, and process conditions that serve as initial and boundary conditions. The numerical method may be based on a boundary integration approach that focuses on solving unknowns of a flow front and includes methods for reducing the solution calculations to accelerate the simulation, as disclosed further below.

Applications of such a fast-numerical method may include, but are not limited to, computer simulation of injection molding, gate location optimization for mold designs, processing parameter optimization, as well as smart manufacturing controls. An example embodiment of such a method may employ a geometrical representation of a part cavity and such representation may be a surface mesh, such as a STereoLithography (STL) representation of the part cavity for non-limiting example. An example embodiment may employ at least one processor that may include at least one graphic processing unit (GPU) for accelerating computation of the numerical method.

An example embodiment of such a numerical method solves a complicated set of partial differential equations (PDEs) that govern the three-dimensional (3D) non-Newtonian, non-isothermal flows. The complicated set of PDEs is developed based on a dimensional reduction approximation method --- a boundary integration approach (Jin, Xiaoshi, “Developments on Computer Simulation of Injection Moulding - Modelling with Boundary Element and Finite Element Methods,” Ph.D. Thesis, University of Glasgow, 1992) of the Generalized Newtonian Flow (GNF) constitutive model in the Chiang-Hieber-Wang equation set (Chiang, H. H., Hieber, C.A., Wang, K. K., “A Unified Simulation of the Filling and Postfilling Stages in Injection Molding. Part I: Formulation,” POLYMER ENGINEERING AND SCIENCE, JANUARY 1991, Vol. 31, No. 2). According to an example embodiment, a method based on such a set of PDEs may be employed as a basis for simulation of polymer flow in a thin-cavity in injection molding.

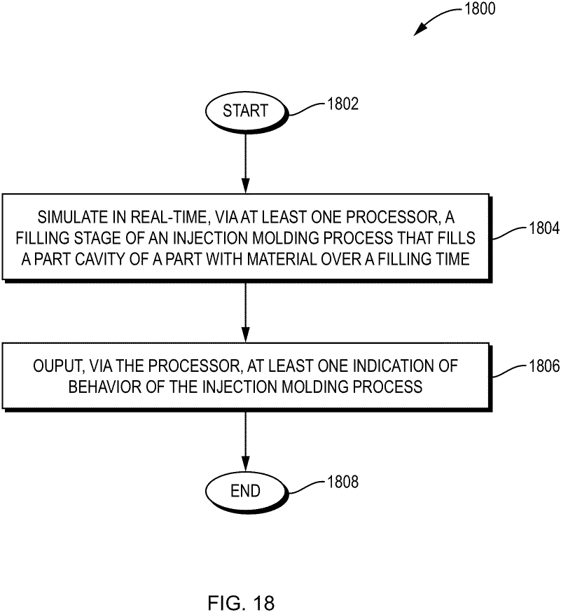

According to an example embodiment of such a method, unknowns are on a boundary and the 3D GNF problem is reduced to a one-dimensional (1D) equation set, which is then solved with an efficient boundary element method according to an example embodiment. Such efficiency accelerates processor computational performance. An example embodiment of such a method is disclosed further below with regard to FIG. 18. Such an example embodiment achieves fast turn-around time without losing much accuracy compared to solving the same PDE set with other 3D domain-based methods that solve the unknowns in a discretized domain mesh, as disclosed further below.

### Formulation of the Boundary Integration Equation Set

A gap-average velocity equation set is given by (Hieber, C.A. and Shen, S.F. “A Finite-Element/Finite-Difference Simulation of the Injection-Molding Filling Process”, Journal of non-Newtonian Fluid Mechanics, Vol. 7, 1-32, 1980) as follows:

$${\overline{u}}_{k} - S {P}_{, k} = 0 k = x , y \qquad \text{(1)}$$

where u̅ₓ and u̅_{y} are the velocity components in x- and y- directions, comma denotes the space derivative, P is the pressure,

$$S = \frac{1}{b} {\int }_{0}^{b} {\int }_{z}^{b} \frac{{z}^{′}}{η} d {z}^{′} d z$$

and η is the viscosity which can be described by the Cross-Williams-Landel-Ferry (Cross-WLF) model below:

$$η = {η}_{0} \left(T , P\right) {\left[1 + {\left(\frac{{η}_{0} \left(T , P\right) \dot{γ}}{{τ}^{*}}\right)}^{1 - n}\right]}^{- 1} \qquad \text{(2a)}$$

in which the zero-shear-rate viscosity is given by

$${η}_{0} \left(T , P\right) = {D}_{1} e x p \left(- \frac{{A}_{1} \left(T - {T}_{0}\right)}{{A}_{2} + T - {T}_{0}}\right) \qquad \text{(2b)}$$

where A₂ = Â₂ + D₃P, T₀ = D₂ + D₃P and D₁, D₂, D₃ and n, A₁, Â₂, τ* are model parameters, T and γ̇ are the temperature and the shear-rate, respectively.

Substituting the continuity condition for compressible fluid into equation (1), a Chiang-Hieber-Wang equation set (Chiang, H. H., Hieber, C.A., Wang, K. K., “A Unified Simulation of the Filling and Postfilling Stages in Injection Molding. Part I: Formulation”, POLYMER ENGINEERING AND SCIENCE, JANUARY 1991, Vol. 31, No. 2) is derived as follows:

$${\left(S {P}_{, k}\right)}_{, k} = G \frac{\partial ρ}{\partial t} + F \qquad \text{(3)}$$

where ρ is the density, G and F are integrations over the thickness which is separated by χ, the solid-liquid interface. Expressions for G and F can be found in (Chiang, H. H., Hieber, C.A., Wang, K. K., “A Unified Simulation of the Filling and Postfilling Stages in Injection Molding. Part I: Formulation”, POLYMER ENGINEERING AND SCIENCE, JANUARY 1991, Vol. 31, No. 2), and they are equal to zero in most of the filling situations, or if a constant density is assumed for the polymer material. The G and F terms may be solved for using a pressure-specific volume-temperature (PVT) model for polymer. Typically, but not exclusively, such a model is the modified 2-domain Tait model (Tait, P.G., “Physics and Chemistry of the voyage of H.M.S Challenger,” Londres. 2 (1888) that is used in polymer flow simulations.

With the Kirchhoff transformation, equation (1) can be transformed to the following integral equation:

$$c \left(ξ\right) υ \left(ξ\right) + {∮}_{\text{Γ}} υ {ϕ}_{, i} {n}_{i} d \text{Γ} = {∮}_{\text{Γ}} ϕ {υ}_{, i} {n}_{i} d \text{Γ} + {∯}_{\text{Ω}} Φ \left(G \frac{\partial ρ}{\partial t} + F\right) d \text{Ω} \qquad \text{(4)}$$

where

$$S = \frac{d υ}{d P} ; {υ}_{, k} = S {P}_{, k} \qquad \text{(5)}$$

where c(ξ) is geometrical dependent constant, c(ξ) =0.5 for ξ on a smooth boundary and c(ξ) =1 for ξ inside the domain, and ϕ is the fundamental solution of the Laplace equation.

Differentiating equation (4) with respect to k (k = x, y) results in the gapwise-average velocity components:

$$c \left(ξ\right) {\overline{u}}_{k} \left(ξ\right) + {∮}_{\text{Γ}} υ {ϕ}_{, i k} {n}_{i} \text{Γ} = {∮}_{\text{Γ}} {ϕ}_{, k} {\overline{u}}_{i} {n}_{i} d \text{Γ} + {∯}_{\text{Ω}} {Φ}_{, k} \left(G \frac{\partial ρ}{\partial t} + F\right) d \text{Ω} \qquad \text{(6)}$$

In fact, this expression is only necessary for points inside the domain. The pressure distribution at any moment can also be solved by a similar integral equation corresponding to equation (3), such as:

$$\begin{matrix}c \left(ξ\right) P \left(ξ\right) + {∮}_{\text{Γ}} P {ϕ}_{, i} {n}_{i} d \text{Γ} = {∮}_{\text{Γ}} ϕ {P}_{, i} {n}_{i} d \text{Γ} + \\ {∯}_{\text{Ω}} Φ \left(\frac{{S}_{, i} {\overline{u}}_{i}}{{S}^{2}} + G \frac{\partial ρ}{\partial t} + F\right) d \text{Ω}\end{matrix} \qquad \text{(7)}$$

The boundary conditions are:

$$\begin{matrix}\overline{u} = \frac{Q}{{F}_{a}} , T = {T}_{m} , a t x = 0 \\ \frac{\partial {v}_{x}}{\partial z} = 0 , \frac{\partial T}{\partial z} = 0 , a t z = 0 \\ u = 0 , \frac{\partial T}{\partial z} = α \left(T - {T}_{s}\right) , a t z = b\end{matrix} \qquad \text{(8)}$$

The boundary integration equations (4-7) involve domain integrations. During the cavity filling stage, the density variation of polymer fluid is small enough that the domain integration contribution can be neglected, the pressure calculation can also be done by subtracting a local pressure drop from a total pressure drop and, therefore, the integral equation (7) can be used for a cross-check.

Due to the dimensional reduction to a one-dimensional boundary, with velocity on the moving boundary being the only unknown to be solved, an example embodiment of such derived boundary integration equations enables a flow solver to compute filling time much faster relative to a conventional finite element method (FEM) or finite volume method (FVM) solver.

The gap-average temperature equation is derived by integration of the energy conservation law over the half cavity thickness:

$$\frac{D \overline{T}}{D t} = α \left(\frac{1}{b} {T}_{, z} \left|{}_{z = b} + {\overline{T}}_{, k k}\right)\right) + H k = x , y \qquad \text{(9)}$$

in which T_{,z} = 0 at the middle of the thickness is used due to the symmetry,

$$\overline{T} = \frac{1}{b} {\int }_{0}^{b} T d z ,$$

$$H = \frac{1}{b} {\int }_{0}^{b} \frac{η {\dot{γ}}^{2}}{ρ {C}_{p}} d z \qquad \text{(10)}$$

in which both the density ρ and the specific heat Cₚ of the polymer are assumed to be position dependent due to the temperature variation across the thickness, and the shear rate γ̇ is defined as

$$\dot{γ} = \sqrt{{v}_{x , z}^{2} + {v}_{y , z}^{2}} = \frac{Λ z}{η} \qquad \text{(11)}$$

which can be used to determine the shear-rate at z location, and the pressure gradient Λ is given as

$$Λ = \sqrt{{P}_{, x}^{2} + {P}_{, y}^{2}} \qquad \text{(12)}$$

Because the viscosity model (2) is temperature and shear rate dependent, the temperature distribution in the z direction is used in determining S and H and, subsequently used in solving the pressure gradients and the gapwise-average temperature fields.

According to an example embodiment, the average velocity u̅ is dependent on Λ and S in the following derivations:

$${\overline{u}}^{2} = {Λ}^{2} {S}^{2} \qquad \text{(13a)}$$

Thus, according to an example embodiment, for the same pressure gradient Λ, the local velocity with mass conservation law can be worked out, that is,

$$\frac{{\overline{u}}_{1}}{{\overline{u}}_{2}} = \frac{{S}_{1}}{{S}_{2}} . \qquad \text{(13b)}$$

For the flow front, the temperature profile across the thickness in the flow front region is approximated with a modified version of one of the analytical solutions by Martin (Martin, B., “Some Analytical Solutions for Viscometric Flows of Power-law Fluids with Heat Generation and Temperature Dependent Viscosity,” Int. J. Non-Linear Mechanics, Vol. 2, pp-285-301) with some modification:

$$T = {T}_{m} + \frac{2}{β} l n \left[\text{cosh} \left(C \frac{z}{b}\right)\right] \qquad \text{(14a)}$$

where β and C are temperature dependent parameters which can be determined by the boundary conditions, such as, at z = b:

$$l n \left[{\text{cosh}}^{2} \left(C\right)\right] = β \left({T}_{w} - {T}_{m}\right) \qquad \text{(14b)}$$

and taking the derivative about z

$${\left(\frac{\partial T}{\partial z}\right|}_{z = b} = \frac{2 C}{b β} \text{tanh} \left(C\right) \qquad \text{(14c)}$$

in which T_{w} is the temperature at z = b, Tₘ is the temperature value in the middle of the thickness (z = 0) which is calculated with (9) in the corresponding boundary integral equation

$$\begin{matrix}c \left(ξ\right) T \left(ξ , t\right) = {\int }_{{t}_{0}}^{t} \left[{∮}_{\text{Γ}} α \left({\overline{T}}_{, i} {T}^{*} - \overline{T} {T}_{, i}^{*}\right) {n}_{i} d \text{Γ} +\right) \\ \left({∯}_{\text{Ω}} \left({\left(\frac{α}{b} {T}_{, z}\right|}_{z = b} + H\right) {T}^{*} d \text{Ω}\right] d {t}^{′} + {∯}_{{\text{Ω}}_{0}} {\left(\overline{T} {T}^{*}\right|}_{{t}_{0}} d \text{Ω}\end{matrix} \qquad \text{(15)}$$

where Ω and Γ are the domain and its boundary at time t, Ω₀ is the domain at time t₀, and T* is the fundamental solution of a classical diffusion equation.

Equations (13, 14) are example embodiments of formulas that may be employed in this disclosure for speeding up the solution (filling time) calculation. The focus of the calculation is on the moving boundary of the flow front. Moreover, any of the domain variables can be worked out with the boundary integration equations after the unknowns at the moving boundary are solved. The present disclosure also includes variations of the velocity and the temperature profile solutions in the z (cavity thickness) direction, provided these profiles are not solved with a discretized numerical method.

### Numerical Implementation

### Boundary Element Approach

The mesh employed for an example embodiment of a boundary element method (BEM) model is a shell (mid-plane) mesh or a surface mesh of a thin-wall part cavity. For a 3D mesh the BEM method can be used in the present disclosure with a surface mesh extraction method from the 3D mesh. Very thick parts with 3D features that have a detailed geometric description, and a corresponding BEM model (see reference (Jin, Xiaoshi, “Developments on Computer Simulation of Injection Moulding - Modelling with Boundary Element and Finite Element Methods”, Ph.D. Thesis, University of Glasgow, 1992)) can apply, but the advantage of a fast solution may be lost for those large 3D mesh models.

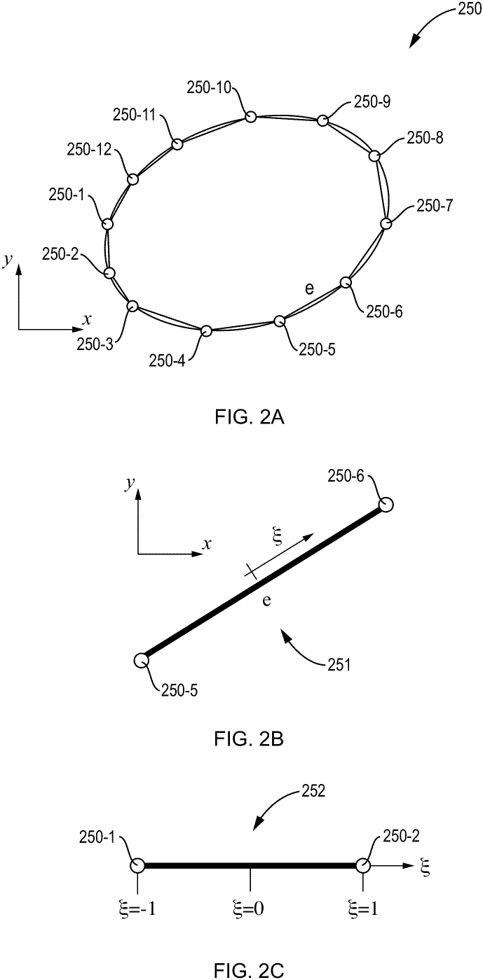

The basic features of the numerical implementation of the boundary integral equations may be the same as those in finite element approximations. Hence the boundary Γ is approximated by the union of boundary elements Γᵢ(i = 1, N_{Γ}). Boundary nodes are defined for each boundary element as shown in FIG. 2A, disclosed below.

FIGS. 2A-C are line drawings of example embodiments of linear boundary elements and boundary nodes. FIG. 2A is a line drawing of an example embodiment of a boundary 250 formed by a plurality of boundary nodes that includes boundary nodes 250-1, 250-2, 250-3, 250-4, 250-5, 250-6, 250-7, 250-8, 250-9, 250-10, 250-11, and 250-12 forming a boundary. FIG. 2B is a line drawing of an example embodiment of a segment 251 between the boundary nodes 250-5 and 250-6 of FIG. 2A. FIG. 2C is a line drawing of an example embodiment of a segment 252 between the boundary nodes 250-1 and 250-2 of FIG. 2A.

With reference to FIGS. 2A-C, the boundary 250 represents a boundary of a thin-wall cavity that is represented by a number of connected curve segments. Each of the curve segments, such as e, is defined by two or three boundary nodes of the boundary nodes 250-1, 250-1, ... 250-12. In a shell mesh, all the edges (an edge is defined by only one element connected to it in mid-plane shell mesh) of the shell mesh are boundary elements, and they are used in addition to the moving flow front which is described either by linear elements or by curved boundary elements. A two-node segment is called a linear boundary element and a three-node segment is called a parabolic curved boundary element. An example embodiment of the present disclosure may include both two-node and three-node boundary elements.

The shape function used for describing any variable distribution along the two-node line boundary element is a linear function, and a parabolic function is used for describing the variable distribution along a three-node curved boundary element. For example, if a value is already known on one of the boundary nodes, and another value at ξ on the line is also known, then the other boundary nodal value can be worked out with the following formula:

$${t}_{2} = \left[t \left(ξ\right) - \frac{\left(1 - ξ\right) {t}_{1}}{2}\right] \frac{2}{\left(1 + ξ\right)} \qquad \text{(16a)}$$

For a 3-node quadratic element, the following Serendipity shape function may be used:

$${N}_{2} = 1 - {ξ}^{2} , {N}_{n} \left(ξ\right) = \frac{1}{2} \left(1 + {ξ}_{n} ξ\right) - \frac{1}{2} {N}_{2} , n = 1 , 3 \qquad \text{(16b)}$$

Any position in the curve can be calculated by:

$$\left\{\begin{matrix}x \\ y \\ z\end{matrix}\right\} = {\sum }_{n = 1}^{3} {N}_{n} \left(ξ\right) \left\{\begin{matrix}{x}_{n}^{e} \\ {y}_{n}^{e} \\ {z}_{n}^{e}\end{matrix}\right\} \qquad \text{(16c)}$$

The shortest distance from a point to a parabolic curve may be calculated in the following distance equation, as described below:

$${d}^{2} = {\left({N}_{1} \left(ξ\right) {\vec{p}}_{1} + {N}_{2} \left(ξ\right) {\vec{p}}_{2} + {N}_{3} \left(ξ\right) {\vec{p}}_{3} - {\vec{p}}_{0}\right)}_{i i}^{2} . \qquad \text{(17)}$$

The condition for the shortest distance is that (18) equals zero, that is,

$$\left({\text{Δ}}_{i} {p}_{1 i} \frac{\partial {N}_{1}}{\partial ξ} + {\text{Δ}}_{i} {p}_{2 i} \frac{\partial {N}_{2}}{\partial ξ} + {\text{Δ}}_{i} {p}_{3 i} \frac{\partial {N}_{3}}{\partial ξ}\right) = 0 \qquad \text{(18)}$$

With a cubic equation of ξ with three roots, one of them in the domain (-1, 1) must be the minimum, there could be two minima or three. For a curved flow front described by 3-point parabolic curve in parametric form with (17-18), to reach to a node in the advancement of the flow front, the point has to be on the convex side of the curve, and there is only one minimum distance point.

### Thickness Calculation

The surface mesh model is not only employed to confine the flow inside the cavity, but is also employed to calculate the flow in the same way as in a mid-plane mesh. Due to the fact that most plastic parts are thin-wall --- the ratio between the edge surface area and total surface area is very small and, as such, the surface mesh model could be viewed as two imprinted surfaces with added edge surface(s) to enclose the part body. This type of surface model is often called a bi-surface model.

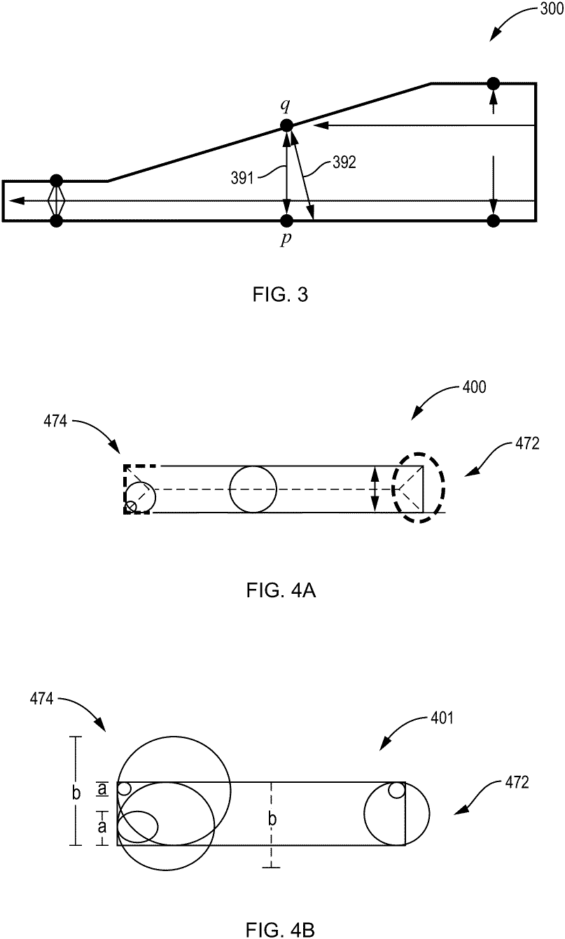

An example embodiment of the present disclosure may be based on a reliable thickness distribution of a bi-surface model of a thin-wall part, or a part that is represented by a mid-plane model. A STL surface representation is such a bi-surface model. The correct and accurate thickness calculation of a thin-wall part cavity is useful. According to an example embodiment, a ray-tracing method may be first used for most of the thickness calculation, then a shrinking-ball method may be used for refining the calculation and correcting dubious thicknesses in particular areas, such as the edges and joint areas under ribs. In particular, the ray-tracing method produces dubious thickness values as shown in FIG. 3, disclosed below.

FIG. 3 is a representation 300 of a ray-tracing method issue. Depending on where the ray starts, a point can have two different thickness values and different opposite facets. For example, two rays, namely ray 391 and ray 392 are shown starting from the point “q” in the representation 300. Multiple thickness values can result based on the rays 391 and 392 presenting ambiguity with regard to the thickness. Some big and unrealistic thickness values on edge or under-rib facets can result. As such, the ray-tracing method produces dubious thickness values as shown in the representation 300, where two thickness values on a point could be produced within a loop to all surface representations for the thickness calculation, and unrealistic thickness values on edge and under-rib facets pose an issue. These issues are corrected by a shrinking-ball method added after a ray-tracing method is applied. The edge and corner thicknesses in a shrinking-ball method could, however, lead to zero thickness as shown in FIG. 4A, disclosed below.

FIG. 4A is a plot 400 of the edge 472 and corner 474 thickness issue resulting from the shrinking-ball method.

FIG. 4B is a plot 401 of a result of applying a correction method on the edge 472 and corner 474 thickness resulting from the shrinking-ball method in which thickness at the edge is (a+b)/2.

### Split Flow Front

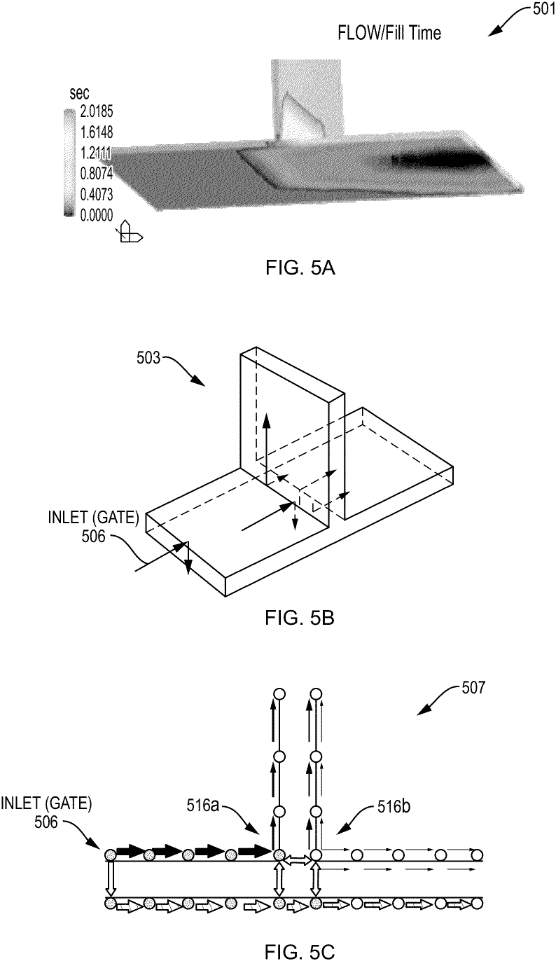

In either a mid-plane model or a bi-surface model, splitting of the flow front is inevitable when the flow front reaches a joint area as shown in FIG. 5A, disclosed below.

FIG. 5A is a plot 501 of an example embodiment of a split of a flow front at a juncture.

FIG. 5B is a block diagram of an example embodiment of a bi-surface model 503 with an inlet gate 506 on one surface.

FIG. 5C is a block diagram of an example embodiment of a split flow front 507. With reference to FIGS. 5A-C, with the bi-surface model 503 with the inlet gate 506 on one surface, one of the key points in the present disclosure is that the flow front 507 is split into the opposite surface at the inlet gate 506 and at the joint areas 516a, 516b as shown in FIG. 5B (Chiou, Shiaw-Yuh, “B-Style (Binary Model) FLOW-PACK Principles”, Internal document, 1997). At those areas, a runner element at the nodal level may be used as a connection bridge from one side to the opposite side. The special characteristics of the runner connection element may include:
(1) letting flow go through the thickness with a high flow conductance; and
(2) it is massless, thus no additional volume added to break the mass conservation.

This split is then realized by connecting the opposite side nodes with a massless high flow conductance runner connection element, and building the flow front nodes the same way as described above. In an embodiment, the total boundary nodes are looped to find the next layer of boundary nodes in either side of the bi-surface model in each time step, and the previous boundary nodes are replaced with the newly collected boundary nodes to move forward, thus, advancing the moving boundary.

### Time Step Requirement for Advancing Flow Front

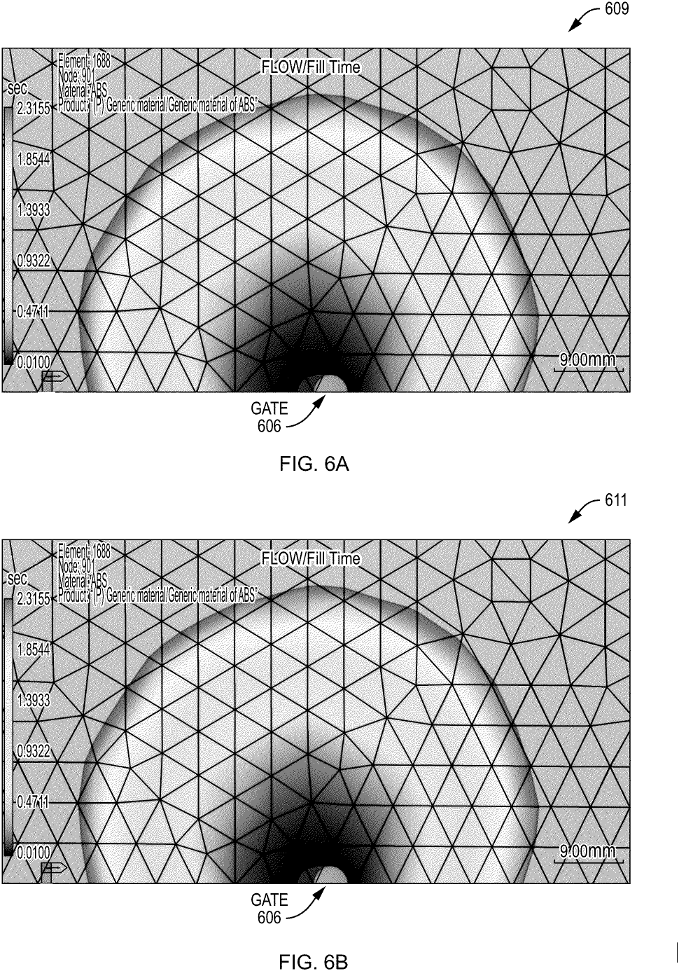

An example embodiment of the present disclosure includes a good flow front advancement method. It is useful to have a clear and smooth free surface boundary for matching the flow front as the fill time (filling time) goes on. The advancement amount at each time step represents the amount of material, such as a polymer or other material, that is injected into the cavity during the time step. FIGS. 6A and 6B, described below, are plots 609 and 611, respectively, of example embodiments of such advancement.

FIG. 6A is a plot 609 of an example embodiment of flow front advancement from a gate 606 at a first time step of two consecutive time steps. In the plot 609 the color coding shows the flow front advancing over time.

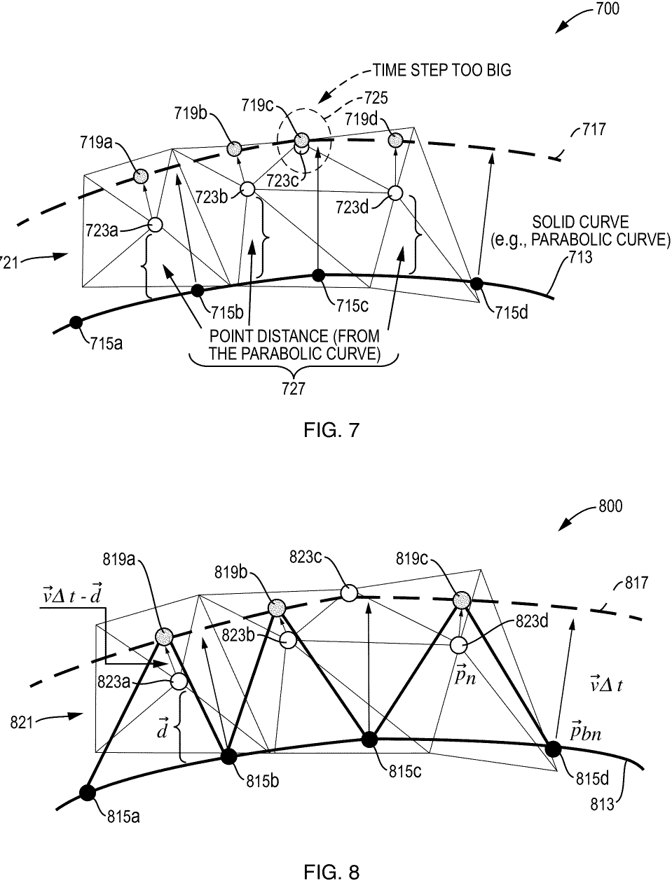

FIG. 6B is a plot 611 of an example embodiment of the flow front advancement at a second time step of the two consecutive time steps. In the plot 611 the color coding shows the flow front advancing over time. With reference to FIGS. 6A-B, the flow front advancement within a time step is controlled within a characteristic length of a smallest element of an element layer in front of the moving boundary. FIG. 7, disclosed below is a schematic view of such advancement.

FIG. 7 is a schematic view 700 of an example embodiment of the flow advancement of FIGS. 6A-B within a time step. In the schematic view 700, the advancement of the boundary nodes within a time step is illustrated as follows. The solid curve 713 and nodes 715a, 715b, 715c, and 715d represent the flow front boundary element (BE) curve and corresponding BE nodes before the time step. The solid curve 713 is a parabolic curve. The dotted curve 717 and open red-blue nodes 719a, 719b, 719c, and 719d represent the new flow front curve position after the time step. The blue triangles 721 and nodes 723a, 723b, 723c, and 723d are the surface triangular mesh that the flow is going through, e.g., a representation of the surface of the part cavity within which the flow front is advancing. A parabolic distance 727 is shown for the 723a, 723b, and 723c nodes relative to the parabolic curve, that is, the solid curve 713.

If the time step is too big, some next layer of nodes could be included in the new flow front curve, as shown in the black-dotted circle 725 which requires the code to loop one more layer of triangles. In order to speed up the loop, a single layer of nodes from the current flow front position (BE nodes) is looped in this method, so the node 723c of the black-dotted circle 725 could be missed out in the next time step if the flow front is ahead of the node. Therefore, good control of the time step is key to a quick solution, that is, at each time step, at most only a single layer of elements will be included for the flow front advancement.

According to an example embodiment, the mass conservation is achieved by calculating the amount of flow advancement between the two flow front curves, that is, before and after the time step, and this flow amount must be equal to the volume flow rate times (multiplied by) the time step. The flow advancement amount is calculated by building triangles between the flow front curves as shown in FIG. 8, disclosed below.

FIG. 8 is a schematic view 800 of an example embodiment of building triangles 821 by connecting nodes of flow front curves (black solid lines) along with the BE lines 813 and 817. The solid curve 813 and nodes 815a, 815b, 815c, and 815d represent the flow front BE curve and corresponding BE nodes before the time step. The dotted curve 817 and open red-blue nodes 819a, 819b, and 819c represent the new flow front curve position after the time step. The blue triangles 821 and nodes 823a, 823b, 823c, and 823d are the surface triangular mesh that the flow is going through. According to the example embodiment of FIG. 8, the position of a newly collected boundary node (823a, 823b, 823d) is calculated as follows:

$${\vec{p}}_{b n} = {\vec{p}}_{n} + {\vec{v}}_{n} \text{Δ} {t}_{n} \text{-} \vec{d} \qquad \text{(19)}$$

where p̅ₙ is the position of a triangle mesh node that a boundary node p̅_{bn} covers. The arrival fill time of p̅ₙ is

$${t}_{n} = {t}_{i} + d / \overline{v} \qquad \text{(20)}$$

where tᵢ is the current (i^{th}) time of the moving boundary.

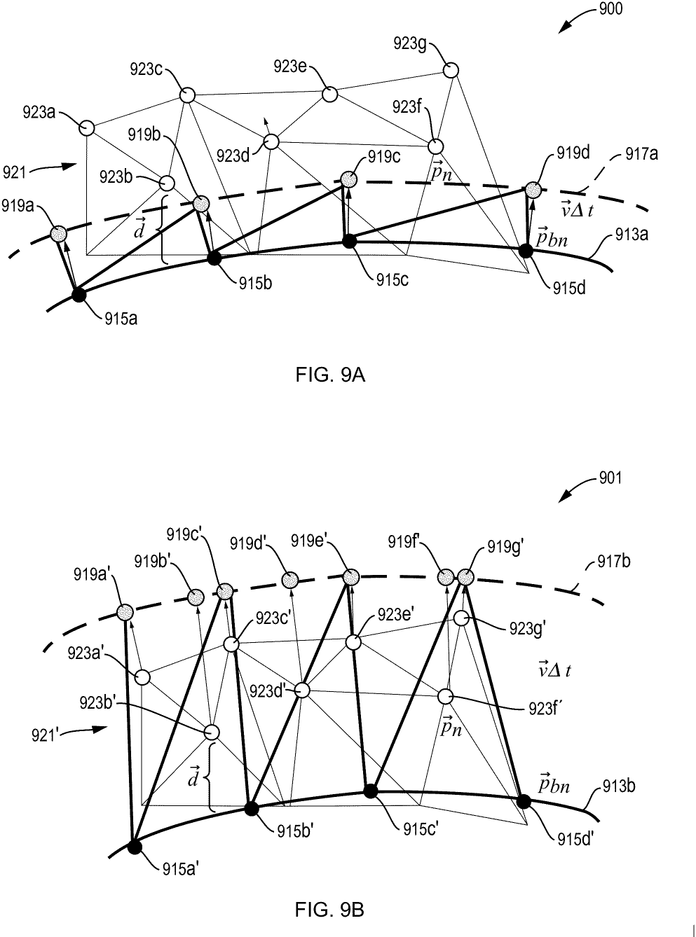

The time step size is useful in terms of method stability, and a major factor for the mass conservation. Its size determination influences the dependency of the mesh, as if it is too small, a mesh node in between two consecutive moving boundary nodes could be missed, forming an artificial entrapment during the filling stage. If it is too big, more than one mesh node could be covered along the flow direction of a boundary node. The arrival time to these nodes may not be linearly represented (21), due to the speed and velocity vector direction which may change during such a big (large) time step, as shown in FIGS. 9A-B, disclosed below.

FIG. 9A is a schematic view 900 of an example embodiment of flow front advancement with a time step that is too small. In the example embodiment of FIG. 9A, the solid curve 913a and nodes 915a, 915b, 915c, and 915d represent the flow front boundary BE curve and corresponding BE nodes before the time step. The blue triangles 921 and nodes 923a-g are the surface triangular mesh that the flow is going through. The dotted curve 917a and open red-blue nodes 919a, 919b, 919c, and 919d represent the new flow front curve position after the time step. As shown in the example embodiment of FIG. 9A, because the time step is too small, none of the next layer mesh nodes 923a, 923b, 923c, 923d, 923e, 923f, and 923g could be covered within the time step.

FIG. 9B is a schematic view 901 of an example embodiment of flow front advancement with a time step that is too big. In the example embodiment of FIG. 9B, the solid curve 913b and nodes 915a′, 915b′, 915c′, and 915d′ represent the flow front BE curve and corresponding BE nodes before the time step. The blue triangles 921′ and nodes 923a′-g′ are the surface triangular mesh that the flow is going through. The dotted curve 917b and open red-blue nodes 919a′, 919b′, 919c′, 919d′, 919e′, 919f′, and 919g’ represent the new flow front curve position after the time step. As shown in the example embodiment of FIG. 9B, because the time step is too big, too many of the next layer mesh nodes 923a′, 923b′, 923c′, 923d′, 923e′, 923f′, and 923g′ are covered within the time step.

With reference to FIGS. 9A and 9B, the ideal time step should cover just one layer or more conservatively, just one node at a time step. If the mesh size is very big, however, the time step is too big to be accurate. Therefore, a pre-determined number of time steps may be provided as an initial estimate of the time step, then the actual time step may be calculated at the end of each estimated time step according to an example embodiment, as described below.

The front area A(tᵢ) of each (i^{th}) time step may be used to determine the average speed u̅ᵢ(=|u̅ᵢ|), and the time step size Δtᵢ, based on the flow-rate Q(tᵢ) of the current time tᵢ, and the average distance d̅_{℩} covered by the average speed:

$${\overline{u}}_{i} = \frac{{Q}_{i}}{{A}_{i}} {\overline{u}}_{i} = \frac{{\overline{d}}_{i}}{\text{Δ} {t}_{i}} \qquad \text{(21)}$$

where Qᵢ = Q(tᵢ), Aᵢ = A(tᵢ), u̅ᵢ = u̅(tᵢ), d̅ᵢ = d̅(tᵢ).

The front volume between the beginning of the time step and the end of the i^{th} time step may be described as:

$$\text{Δ} {V}_{i} = \text{Δ} {t}_{i} {Q}_{i} = {\overline{d}}_{i} {A}_{i} \qquad \text{(22)}$$

$$\text{Δ} {t}_{i} = \frac{{\overline{d}}_{i} {A}_{i}}{{Q}_{i}} = \frac{\text{Δ} {V}_{i}}{{Q}_{i}} \qquad \text{(23)}$$

Therefore, an accurate calculation of the front volume ΔVᵢ is useful in determination of the time step, and in the mass conservation and total time accumulation. The average speed ūᵢ is determined by the flow-rate divided by the front area, thus, the accurate calculation of the front area Aᵢ is also useful. Since the front volume is calculated at the end of the time step, whereas the front area is calculated at the end of the previous time step, the time step itself may be updated after each time step when the front volume is calculated, such as:

$$I n i t i a l e s t i m a t e d t i m e s t e p \text{Δ} {t}_{i} = \frac{{t}_{f i l l}}{N} \to \text{Δ} {V}_{i} \to \text{Δ} {{t}^{′}}_{i} = \frac{\text{Δ} {V}_{i}}{{Q}_{i}} \qquad \text{(24a)}$$

$${t}_{f i l l} = {\sum }_{i = 1}^{N} \text{Δ} {{t}^{′}}_{i} = {\sum }_{i = 1}^{N} \frac{\text{Δ} {V}_{i}}{{Q}_{i}} \qquad \text{(24b)}$$

The eventual fill time summed up (accumulated) by (24b) may not be exactly equal to the pre-set fill time, but it won’t be too far off, provided that the number of time steps is properly set and the front volume at the end of each time step is calculated accurately. The fill time that is accumulated (24b) may be considered to be a real-time fill time.

The whole mass conservation is kept with the following check, with use of (13b):

$${\overline{u}}_{i} = \frac{{Q}_{i}}{{A}_{i}} = \frac{1}{{A}_{i}} {\sum }_{k = 1}^{{N}_{f f}} \left({A}_{i k} {\overline{u}}_{i k}\right) \qquad \text{(25)}$$

where N_{ff} is the number of the flow front boundary elements, and Aᵢₖ, u̅ᵢₖ the front area and average speed of the k^{th} element at the i^{th} time step. The flow front advancement is less dependent on the mesh, and more dependent on the number of steps and the accuracy of tracking flow front at each time step.

### Solution Strategy in Steps

An example embodiment of the disclosure includes more than one method to solve the equation set with a boundary integration method. An example embodiment of a fast solution strategy of the disclosure may include solving the gap-average velocity u̅ and gap-average temperature T̅ on the flow front boundary first, with the analytical solutions of the temperature and velocity across the thickness, then solving the incremental pressure drop before updating the flow front boundary position.

The fast solution strategy may also include a proposed temperature profile and velocity profile across the thickness based on equation (14). It is found that these changes only affect the pressure prediction, and the difference only by a scaling factor, compared to a domain discretization solution. An example embodiment of a proposed temperature profile may include:

$$T = {T}_{w} - \frac{2}{s β} l n \left[C + \left(1 - C\right) {\left(\frac{z}{b}\right)}^{s + 2}\right] . \qquad \text{(26a)}$$

where β is a thermal dependency parameter, and s is the inverse of power-law index of an equivalent power-law viscosity model. C is a gapwise-average temperature dependent parameter which can be determined by taking z to be zero:

$$l n \left(C\right) = \frac{s β}{2} \left({T}_{w} - {T}_{m}\right) \qquad \text{(26b)}$$

and taking the derivative about z at z = b:

$${\left(\frac{\partial T}{\partial z}\right|}_{z = b} = \frac{2}{s β} \left(C - 1\right) \left(s + 2\right) . \qquad \text{(26c)}$$

With the above-noted approximations, the solution speed (time to simulate filling of the filling stage) can be significantly improved.

The present solution strategy may include the following:
1. Calculate the part thickness distribution from a surface representation of the part cavity
2. Determine process parameters including flow rate distribution and time steps based on process conditions
3. Calculate the average thickness distribution of the flow front and the average fluidity
4. Calculate the average advancing speed of the flow front ū
5. Calculate the average temperature T̅ of the flow front
6. Calculate temperature and shear-rate dependent integration for the fluidity S on each flow front node
7. Use the speed ratio with the average advancing speed to calculate the flow front nodal speed
8. Advance the flow front according to all the flow front nodal speeds, within the surface representation of the cavity geometry
9. Calculate pressure and temperature distributions according to the advanced flow front location, and check if the injection molding machine pressure limit is reached or the whole flow front temperature drops below the polymer freezing temperature.
10. Go back to step 2 for the next time step, continue the same steps to loop until the cavity is completely filled or one of the limits in step 9 is reached.

### Graphic Process Units (GPU) Accelerated Computing

An example embodiment of the disclosure includes the parallelization of the integrations, especially for graphics processing unit (GPU) acceleration since the integration for each calculation point can be independently done within a GPU thread, especially after the boundary values are known for each time step. The thickness calculation with ray-tracing and shrinking-ball methods, disclosed above in relation to FIGS. 3, 4A, and 4B, may also be GPU accelerated in this disclosure.

### Validation

Two examples have been used to validate the present disclosure. They are from internal test models and reference (Pignon, B., Sobotka, V., Boyard, N., Delaunay, D., “Improvement of heat transfer analytical models for thermoplastic injection molding and comparison with experiments”, International Journal of Heat and Mass Transfer · October 2017), and each provides the filling stage calculation time, and the last domain-based solutions with the CPU time spent.

### Test Case One

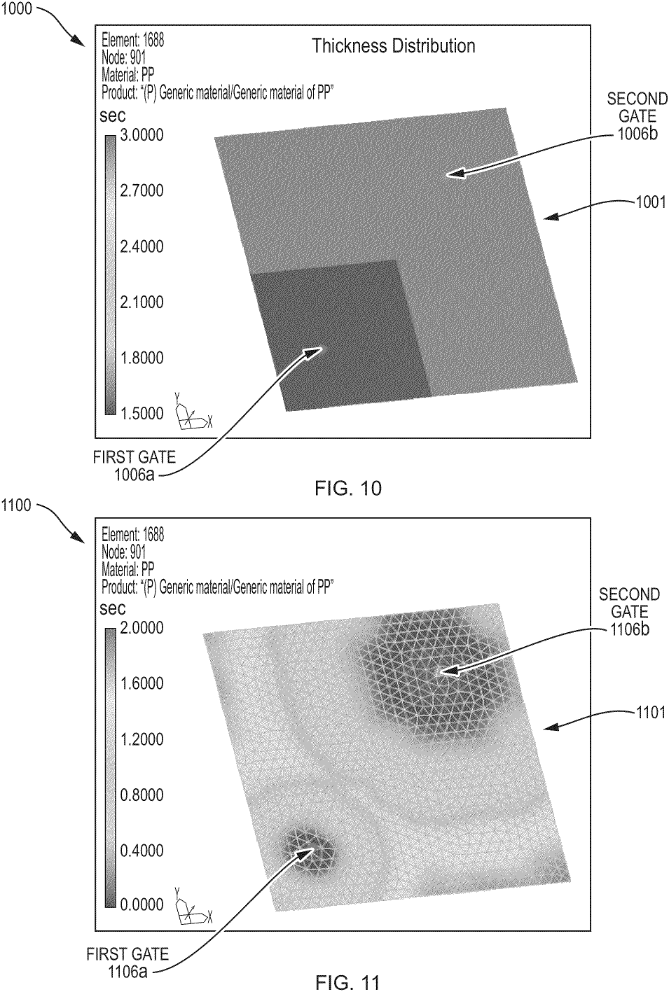

This case study is a square plate of 160 mm × 160 mm × 3 mm, but with a quarter of it thinned down to 1.5 mm thick, as shown in FIG. 10, disclosed below. The case can be used for any material and with reasonable process conditions, as long as it fills the part, or even if it will not fill the part, because it is mainly a non-uniform thickness polymer flow test.

FIG. 10 is a thickness distribution plot 1000 of an example embodiment of a thickness distribution of a square plate 1001 (160×160 mm) used in test Case One. A quarter of the square plate 1001 is 1.5 mm thick, the rest of it is 3 mm thick. The material is injected at a first gate 1006a and second gate 1006b. The same geometry has been meshed with a mid-plane mesh, a bi-surface mesh, and a solid 3D hexahedron (hex) mesh, and the present disclosure can run on all of these mesh models.

Two gates 1106a and 1106b at different thickness areas are used, as shown on the meshed part of FIG. 11, disclosed below, to see the polymer viscosity influence on the non-Newtonian flow in the melt front advancement from which the proof of concept of equation (13) is validated.

FIG. 11 is a plot 1100 of an example embodiment of a filling pattern of the plate 1001 of FIG. 10 that is determined from a computer simulation that employs an example embodiment of a method disclosed herein on the mid-plane mesh 1101. The material is injected at a first gate 1106a and second gate 1106b. The filling pattern is represented by the color coding.

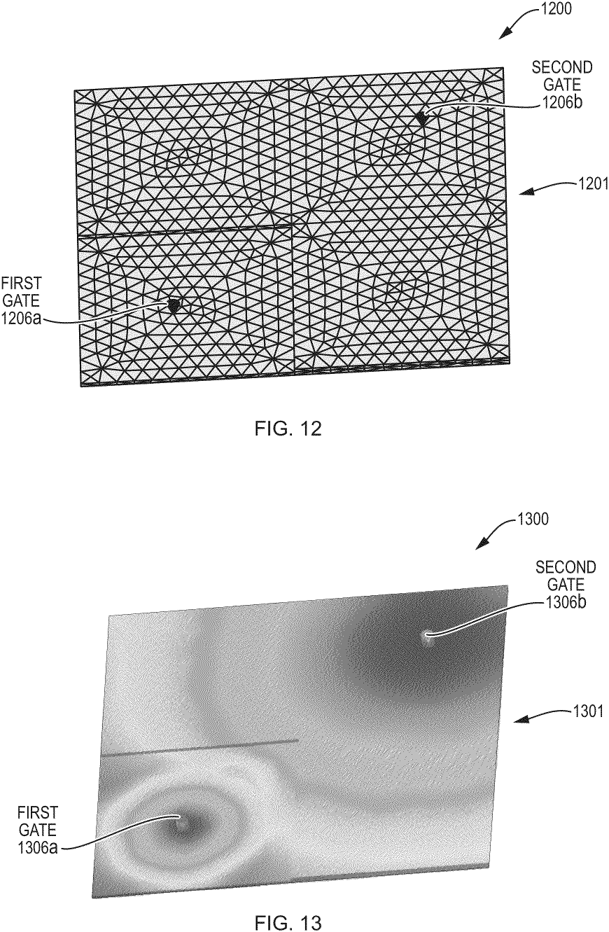

FIG. 12 is a depiction 1200 of an example embodiment of a surface mesh model 1201 of test Case One that uses the same square plate geometry of FIG. 10, disclosed above. The material is injected at a first gate 1206a and second gate 1206b.

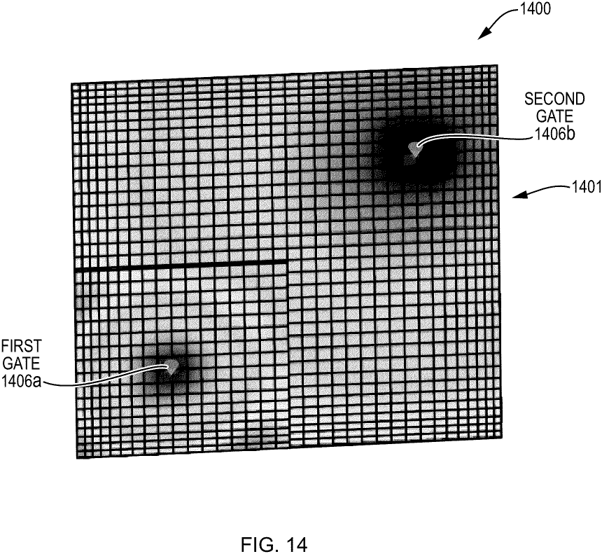

FIG. 13 is a plot 1300 of an example embodiment of the filling pattern 1301 of the surface mesh model 1201 of FIG. 12 that results from a computer-simulation based on an example embodiment of the present disclosure. That is, the filling pattern 1301 represents the filling pattern that results from a two-gate injection molding simulation with an example embodiment of the present disclosure. In the example illustrated in FIG. 13, the material is injected at a first gate 1306a and second gate 1306b. The same square part is also meshed with a 3D hex mesh, with two similar gate locations. The filling pattern resulting from same is shown in FIG. 14, disclosed below.

FIG. 14 is a plot 1400 of an example embodiment of a filling pattern that results from a computer-simulation based on an example embodiment of the present disclosure on a 3D hexahedron (hex) mesh model 1401 for test Case One. The material is injected at a first gate 1406a and second gate 1406b. The color coding shows advancement of the flow front over time relative to the first gate 1406a and second gate 1406b.

The calculation time spent on these three mesh models, namely the mid-plane mesh model 1101, surface mesh model 1201, and 3D hex mesh model 1401, with the present disclosure are 0.105 sec., 0.271 sec. and 1.6 sec., respectively, on a laptop of 2.6 GHz, 6 Cores.

### Test Case Two

The case study of Test Case Two is based on the framework of the Shrinkage and Warpage in Injection Molding (SWIM) project which was well tested for shrinkage and warpage study more than 20 years ago, but the focus of the paper (Pignon, B., Sobotka, V., Boyard, N., Delaunay, D., “Improvement of heat transfer analytical models for thermoplastic injection molding and comparison with experiments,” International Journal of Heat and Mass Transfer · October 2017) was mainly on matching the pressure and temperature measurements with characterization of the thermal contact resistance (TCR). The model geometry, process conditions, material data and the overall pressure prediction are used here for comparison.

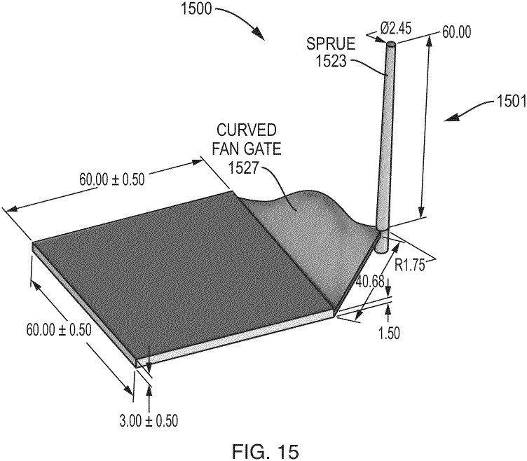

FIG. 15 is a schematic view 1500 of a fan gate 1527 of an ISO plaque 1501 used as a model geometry in test Case Two. The ISO plaque 1501 has a sprue 1523.

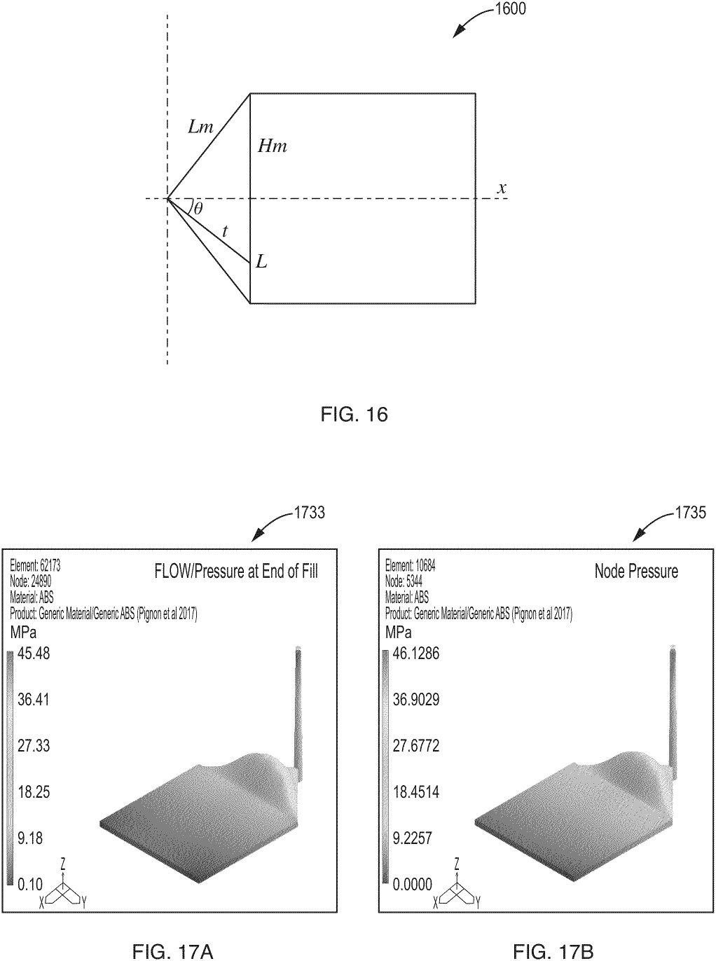

FIG. 16 is a schematic top-view 1600 of the curved fan gate 1527 of FIG. 15. With reference back to FIG. 15, the model geometry of the ISO plaque (60 mm × 60 mm × 3 mm) 1501 has an injection entrance at the top of the tapered sprue 1523 of 60 mm, with the curved fan gate 1527 of 1.5 mm thick. The plastic material used is a generic ABS material with thermal and PVT properties from the paper (Pignon, B., Sobotka, V., Boyard, N., Delaunay, D., “Improvement of heat transfer analytical models for thermoplastic injection molding and comparison with experiments”, International Journal of Heat and Mass Transfer · October 2017).

The process conditions are:

| | |
|---|---|
| Melt Temperature | 240 C |
| Injection Time | 1 sec. |
| Mold Temperature | 65 C |
| Packing pressure | 70 MPa |
| Packing time | 12 sec. |
| Cooling time | 21.4 sec. |

A curved fan gate 1527 is designed in order to create a flat flow front in the ISO plaque 1501. The curve surface of the fan gate 1527 is defined with the following function:

$${\int }_{0}^{L} \sqrt{1 + {\left(\frac{d f}{d t}\right)}^{2}} d t = {L}_{m} , t = \frac{x}{c o s θ} \qquad \text{(27)}$$

The boundary conditions for the curved surface are given below:

$$f \left(t\right) = 0 , \frac{d f}{d t} = 0 , a t \left\{\begin{matrix}t = 0 \\ t = L\end{matrix}\right) \qquad \text{(28)}$$

The following transcendental function satisfies the conditions (28):

$$f \left(x , y\right) = \frac{a x}{cos θ L \left(y\right)} s i {n}^{2} \left(\frac{x π}{cos θ L \left(y\right)}\right) \qquad \text{(29)}$$

where α is determined by condition (27).

In test case 2, the part geometry 1501 is meshed with 39548 solid cells, and the wall clock time used with a domain mesh solver for the filling stage is 464.94 sec., and the CPU time used is 4650.17 sec. All the calculations are done on the same laptop of 2.6 GHz, 6 Cores.

The fast flow solver disclosed herein completed the calculation of the filling stage of the same mesh in 1.944 seconds of CPU time which includes the thickness calculation and the extraction of the surface mesh from the solid mesh. If just the surface mesh is used, the CPU time is around 1.2 seconds, which is very close to the filling (fill) time used for the filling stage and, thus, the real-time physics can be fulfilled with this solver.

FIGS. 17A-B are plots 1733 and 1735, respectively, of pressure predictions for the plaque 1501 of FIG. 15. FIG. 17A is a plot 1733 of pressure predicted by domain mesh solver. FIG. 17B is a plot 1735 of pressure predicted by an example embodiment of a fast flow solver disclosed herein on a surface mesh. The difference between the pressure predictions of FIGS. 17A and 17B is small.

FIG. 18 is a flow diagram of an example embodiment of a computer-implemented method (1800) for determining behavior of an injection molding process. The method begins (1802) and comprises simulating (1804) in real-time, via at least one processor, a filling stage of an injection molding process that fills a part cavity of a part with material over a filling (fill) time, the simulating based on a boundary integration method and a mesh model, the mesh model representing the part cavity, the simulating including computing a part thickness distribution of the part based on the mesh model. The boundary integration method includes computing velocity and temperature at a flow front of the material over the part thickness distribution computed and determining advancement of the flow front based on the velocity and temperature computed. The computer-implemented method 1800 further comprises outputting (1806), via the processor, at least one indication of behavior (physics based and/or chemistry based behaviors) of the injection molding process determined based on the simulating, the simulating transpiring in real-time relative to the filling time. Such behavior may be pattern of a flow of material filling a mold cavity over time.

The at least one indication of behavior may include a filling pattern representing the filling stage, e.g., a visual or other such representation of material flow over time. Amongst other examples, this representation may be provided through color-coded or shade-coded imagery or through a numeric or alphanumeric representation of the behavior. It should be understood that the at least one indication is not limited to a filling pattern and may encompass any behavior of the injection molding process that results from the simulation, or that may be derived based on the simulation. For non-limiting example, said behaviors may be physics-based, materials-based, and/or chemistry-based. The computer-implemented method 1800 thereafter ends (1808) in the example embodiment.

The mesh model representing the part cavity may be a discretized surface representation of a geometry of the part cavity. The determining of the advancement of the flow front may further include determining, on a time-step-by-time-step basis, advancement of a moving boundary of the flow front of the material. The moving boundary may include a plurality of flow front nodes. At each time step of determining the advancement of the moving boundary, the determining may include:
(a) computing the part thickness distribution from the discretized surface representation of the geometry of the part cavity;
(b) determining process parameters, the process parameters including flow rate distribution and time steps based on input process conditions;
(c) computing an average thickness distribution of the flow front and an average fluidity of the flow front;
(d) computing an average advancing speed u̅ of the flow front;
(e) computing an average temperature T̅ of the flow front;
(f) computing a temperature-and-shear-rate dependent integration for fluidity S on each flow front node of the plurality of flow front nodes;
(g) computing a flow front nodal speed for each flow front node of the plurality of flow front nodes, wherein computing the flow front nodal speed includes employing a speed ratio and the average advancing speed;
(h) advancing the moving boundary of the flow front according to each flow front nodal speed computed, the advancing being within the discretized surface representation of the geometry of the part cavity, the advancing producing an advanced flow front location;
(i) computing pressure and temperature distributions according to the advanced flow front location produced and, based on the pressure and temperature distributions computed, determining whether an injection-molding-machine related pressure limit has been reached or a whole flow front temperature has dropped below a polymer freezing-point temperature, wherein the material is a polymer with the polymer freezing-point temperature, and determining whether the part cavity has been filled, completely; and
(j) ending the simulating in an event the injection-molding-machine related pressure limit is determined to have been reached, the whole flow front temperature is determined to have dropped below the polymer freezing-point temperature, or the part cavity is determined to have been filled, completely, and, in an event the simulating is not ended, repeating (b)-(j) for a next time step.

The computer-implemented method 1800 may be implemented via an example embodiment of an internal structure of a computer, such as disclosed below with regard to FIG. 19.

FIG. 19 is a block diagram of an example of the internal structure of a computer 1900 in which various embodiments of the present disclosure may be implemented. The computer 1900 contains a system bus 1902, where a bus is a set of hardware lines used for data transfer among the components of a computer or digital processing system. The system bus 1902 is essentially a shared conduit that connects different elements of a computer system (e.g., processor, disk storage, memory, input/output ports, network ports, etc.) that enables the transfer of information between the elements. Coupled to the system bus 1902 is an I/O device interface 1904 for connecting various input and output devices (e.g., keyboard, mouse, display monitors, printers, speakers, microphone, etc.) to the computer 1900. A network interface 1906 allows the computer 1900 to connect to various other devices attached to a network (e.g., global computer network, wide area network, local area network, etc.). Memory 1908 provides volatile or non-volatile storage for computer software instructions 1910 and data 1912 that may be used to implement embodiments (e.g., method 1800) of the present disclosure, where the volatile and non-volatile memories are examples of non-transitory media. Disk storage 1913 also provides non-volatile storage for the computer software instructions 1910 and data 1912 that may be used to implement embodiments (e.g., method 1800) of the present disclosure. A central processor unit 1918 is also coupled to the system bus 1902 and provides for the execution of computer instructions.

Further example embodiments disclosed herein may be configured using a computer program product; for example, controls may be programmed in software for implementing example embodiments. Further example embodiments may include a non-transitory computer-readable-medium that contains instructions that may be executed by a processor, and, when loaded and executed, cause the processor to complete methods and techniques described herein. It should be understood that elements of the block and flow diagrams may be implemented in software or hardware, such as via one or more arrangements of circuitry of FIG. 19, disclosed above, or equivalents thereof, firmware, a combination thereof, or other similar implementation determined in the future.

In addition, the elements of the block and flow diagrams described herein may be combined or divided in any manner in software, hardware, or firmware. If implemented in software, the software may be written in any language that can support the example embodiments disclosed herein. The software may be stored in any form of computer readable medium, such as random-access memory (RAM), read only memory (ROM), compact disk read-only memory (CD-ROM), and so forth. In operation, a general purpose or application-specific processor or processing core loads and executes software in a manner well understood in the art. It should be understood further that the block and flow diagrams may include more or fewer elements, be arranged or oriented differently, or be represented differently. It should be understood that implementation may dictate the block, flow, and/or network diagrams and the number of block and flow diagrams illustrating the execution of embodiments disclosed herein.

GLOSSARY

| | |
|---|---|
| Aᵢ | Viscosity model coefficients (i=1,2) |
| T | Temperature |
| α | Thermal Diffusivity $\left(= \frac{{k}_{p}}{ρ {C}_{p}}\right)$ |
| ̅̅T̅ | Gap-average temperature |
| b | Half thickness |
| kₚ | thermal conductivity of polymer |
| β | Thermal solution parameter |
| s | Inverse of power-law index |
| Cₚ | Specific heat of polymer |
| t | Time |
| c(ξ) | Boundary integration coefficient |
| ξ | Coordniate along boundary curve |
| Dᵢ | Cross-WLF model coefficients (i=1,2,3) |
| τ* | Shear stress parameter |
| d̅ | Moving distance of a point |
| p̅_{bn}, p̅ₙ | Position of a b-node / node at Δtₙ |
| F_{α} | Flow front area |
| nᵢ | normal vector component |
| ϕ | Fundamental solution of Laplace equation |
| ψ | Stream function |
| H | Shear energy term |
| Λ | Pressure gradient |
| η | Viscosity |
| γ̇ | Shear-rate |
| η₀ | Zero-shear viscosity |
| ρ | Density |
| m | Power-law model power-law index |
| s | Inverse of the power-law index (1/m) |
| n | Cross model power-law index |
| T₀ | Reference temperature $\frac{\partial }{\partial t}$ |
| | Partial derivative regard time t |
| ${\left(\frac{\partial }{\partial P}\right)}_{T}$ | Partial derivative on pressure at T |
| ∮_{Γ} dΓ | Integration over boundary Γ |
| _{Ω} dΩ | Integration over domain Ω |
| P | Pressure |
| uₖ | Velocity k component |
| S | Fluidity |
| ū | Gap-average velocity |
| Δtₙ | Nth time step |
| u̅ ₙ | Velocity vector at n^{th} time step |
| χ | Solid-liquid interface location |
| z | Thickness direction |

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A computer-implemented method for determining behavior of an injection molding process, the method comprising:
simulating in real-time, via at least one processor, a filling stage of an injection molding process that fills a part cavity of a part with material over a filling time, the simulating based on a boundary integration method and a mesh model, the mesh model representing the part cavity, the simulating including computing a part thickness distribution of the part based on the mesh model,
the boundary integration method including computing velocity and temperature at a flow front of the material over the part thickness distribution computed and determining advancement of the flow front based on the velocity and temperature computed; and
outputting, via the processor, at least one indication of behavior of the injection molding process determined based on the simulating, the simulating transpiring in real-time relative to the filling time.

2. The computer-implemented method of claim 1, wherein the boundary integration method further includes employing a representation of a moving boundary of the flow front and wherein the representation of the moving boundary is a one-dimensional (1D) element.

3. The computer-implemented method of claim 1, wherein the boundary integration method further includes computing an incremental pressure drop and wherein determining the advancement includes employing the incremental pressure drop computed.

4. The computer-implemented method of claim 1, wherein determining the advancement of the flow front includes determining, on a time-step-by-time-step basis, advancement of a moving boundary of the flow front of the material within the part cavity represented by the mesh model, the simulating including advancing, on the time-step-by-time step basis, the moving boundary based on the advancement determined for the moving boundary.

5. The computer-implemented method of claim 4, wherein the boundary integration method is based on a one-dimensional (1D) boundary-integration equation set of partial differential equations (PDEs) and wherein determining the advancement of the moving boundary includes solving, by the at least one processor, the 1D boundary-integration equation set of PDEs.

6. The computer-implemented method of claim 4, wherein the moving boundary includes a plurality of boundary elements, wherein determining the advancement of the moving boundary includes employing element layers of the mesh model to guide advancement of the plurality of boundary elements, and wherein the boundary integration method further includes:
employing, on the time-step-by-time-step basis, a time increment that prevents a boundary element of the plurality of boundary elements from advancing more than two element layers of the element layers of the mesh model within the time increment.

7. The computer-implemented method of claim 1, wherein the at least one indication of behavior of the injection molding process includes a filling pattern of the filling stage.

8. The computer-implemented method of claim 1, wherein the at least one indication of behavior of the injection molding process includes a graphical representation of the filling stage of the part cavity over time, and wherein outputting the at least one indication includes displaying the graphical representation on a display screen of a computer device.

9. The computer-implemented method of claim 1, wherein the material is a polymer, wherein the part cavity is a thin-wall part cavity, and wherein the mesh model is a mid-plan mesh model or a surface mesh model of the thin-wall part cavity.

10. The computer-implemented method of claim 1, wherein the mesh model representing the part cavity is a discretized surface representation of a geometry of the part cavity, wherein determining the advancement of the flow front includes determining, on a time-step-by-time-step basis, advancement of a moving boundary of the flow front of the material, wherein the moving boundary includes a plurality of flow front nodes and wherein, at each time step of determining the advancement of the moving boundary includes:
(a) computing the part thickness distribution from the discretized surface representation of the geometry of the part cavity;
(b) determining process parameters, the process parameters including flow rate distribution and time steps based on input process conditions;
(c) computing an average thickness distribution of the flow front and an average fluidity of the flow front;
(d) computing an average advancing speed of the flow front;
(e) computing an average temperature of the flow front;
(f) computing a temperature-and-shear-rate dependent integration for fluidity on each flow front node of the plurality of flow front nodes;
(g) computing a flow front nodal speed for each flow front node of the plurality of flow front nodes, wherein computing the flow front nodal speed includes employing a speed ratio;
(h) advancing the moving boundary of the flow front according to each flow front nodal speed computed, the advancing being within the discretized surface representation of the geometry of the part cavity, the advancing producing an advanced flow front location;
(i) computing pressure and temperature distributions according to the advanced flow front location produced and, based on the pressure and temperature distributions computed, determining whether an injection-molding-machine related pressure limit has been reached or a whole flow front temperature has dropped below a polymer freezing-point temperature, wherein the material is a polymer with the polymer freezing-point temperature, and determining whether the part cavity has been filled, completely; and
(j) ending the simulating in an event the injection-molding-machine related pressure limit is determined to have been reached, the whole flow front temperature is determined to have dropped below the polymer freezing-point temperature, or the part cavity is determined to have been filled, completely, and, in an event the simulating is not ended, repeating (b)-(j) for a next time step.

11. A computer-based system for determining behavior of an injection molding process, the computer-based system comprising:
at least one memory; and
at least one processor coupled to the at least one memory, the at least one processor configured to:
perform a computer simulation, in real-time, the computer simulation including simulating a filling stage of an injection molding process that fills a part cavity of a part with material over a filling time, the simulating based on a boundary integration method and a mesh model, the mesh model stored in the at least one memory and representing the part cavity, the simulating including computing a part thickness distribution of the mesh model,
the boundary integration method including computing velocity and temperature at a flow front of the material over the part thickness distribution computed and determining advancement of the flow front based on the velocity and temperature computed; and
output at least one indication of behavior of the injection molding process determined based on the simulating, the simulating transpiring in real-time relative to the filling time.

12. The computer-based system of claim 11, wherein the boundary integration method further includes employing a representation of a moving boundary of the flow front and wherein the representation of the moving boundary is a one-dimensional (1D) element.

13. The computer-based system of claim 11, wherein the boundary integration method further includes computing an incremental pressure drop and wherein determining the advancement includes employing the incremental pressure drop computed.

14. The computer-based system of claim 11, wherein determining the advancement of the flow front includes determining, on a time-step-by-time-step basis, advancement of a moving boundary of the flow front of the material within the part cavity represented by the mesh model, the simulating including advancing, on the time-step-by-time step basis, the moving boundary based on the advancement determined for the moving boundary.

15. The computer-based system of claim 14, wherein the boundary integration method is based on a one-dimensional (1D) boundary-integration equation set of partial differential equations (PDEs) and wherein determining the advancement of the moving boundary includes solving, by the at least one processor, the 1D boundary-integration equation set of PDEs.

16. The computer-based system of claim 14, wherein the moving boundary includes a plurality of boundary elements, wherein determining the advancement of the moving boundary includes employing element layers of the mesh model to guide advancement of the plurality of boundary elements, and wherein the boundary integration method further includes:
employing, on the time-step-by-time-step basis, a time increment that prevents a boundary element of the plurality of boundary elements from advancing more than two element layers of the mesh model within the time increment.

17. The computer-based system of claim 11, wherein the at least one indication of behavior of the injection molding process includes a filling pattern of the filling stage.

18. The computer-based system of claim 11, wherein the at least one indication of behavior of the injection molding process includes a graphical representation of the filling stage of the part cavity over time, and wherein outputting the at least one indication includes displaying the graphical representation on a display screen of a computer device.

19. The computer-based system of claim 11, wherein the mesh model representing the part cavity is a discretized surface representation of a geometry of the part cavity, wherein determining the advancement of the flow front includes determining, on a time-step-by-time-step basis, advancement of a moving boundary of the flow front of the material, wherein the moving boundary includes a plurality of flow front nodes and wherein, at each time step of determining the advancement of the moving boundary includes:
(a) computing the part thickness distribution from the discretized surface representation of the geometry of the part cavity;
(b) determining process parameters, the process parameters including flow rate distribution and time steps based on input process conditions;
(c) computing an average thickness distribution of the flow front and an average fluidity of the flow front;
(d) computing an average advancing speed of the flow front;
(e) computing an average temperature of the flow front;
(f) computing a temperature-and-shear-rate dependent integration for fluidity on each flow front node of the plurality of flow front nodes;
(g) computing a flow front nodal speed for each flow front node of the plurality of flow front nodes, wherein computing the flow front nodal speed includes employing a speed ratio and the average advancing speed;
(h) advancing the moving boundary of the flow front according to each flow front nodal speed computed, the advancing being within the discretized surface representation of the geometry of the part cavity, the advancing producing an advanced flow front location;
(i) computing pressure and temperature distributions according to the advanced flow front location produced and, based on the pressure and temperature distributions computed, determining whether an injection-molding-machine related pressure limit has been reached or a whole flow front temperature has dropped below a polymer freezing-point temperature, wherein the material is a polymer with the polymer freezing-point temperature, and determining whether the part cavity has been filled, completely; and
(j) ending the computer simulation in an event the injection-molding-machine related pressure limit is determined to have been reached, the whole flow front temperature is determined to have dropped below the polymer freezing-point temperature, or the part cavity is determined to have been filled, completely, and, in an event the simulating is not ended, repeating (b)-(j) for a next time step.

20. A non-transitory computer-readable medium having encoded thereon a sequence of instructions which, when loaded and executed by at least one processor, causes the at least one processor to:
perform a computer simulation, in real-time, the computer simulation including simulating a filling stage of an injection molding process that fills a part cavity of a part with material over a filling time, the simulating based on a boundary integration method and a mesh model, the mesh model stored in the at least one memory and representing the part cavity, the simulating including computing a part thickness distribution of the mesh model,
the boundary integration method including computing velocity and temperature at a flow front of the material over the part thickness distribution computed and determining advancement of the flow front based on the velocity and temperature computed; and
output, via the processor, at least one indication of behavior of the injection molding process determined based on the simulating, the simulating transpiring in real-time relative to the filling time.
